(19) United States
(12) Patent Application Publication
(10) Pub. No.: US 2016/0330993 A1
(43) Pub. Date: Nov. 17, 2016

(54) ADVANCED GUM FORMING

(71) Applicant: INTERCONTINENTAL GREAT BRANDS LLC, East Hanover, NJ (US)

(72) Inventors: Richard Steven Grant, Whippany, NJ (US); Leonard Scarola, Whippany, NJ (US)

(21) Appl. No.: 15/108,916

(22) PCT Filed: Dec. 30, 2014
(86) PCT No.: PCT/US2014/072708

§ 371 Date: Jun. 29, 2016

Related U.S. Application Data
(60) Provisional application No. 61/922,228, filed on Dec. 31, 2013.

(51) Int. Cl. A23G 4/04

(52) U.S. Cl. CPC A23G 4/04

(57) ABSTRACT

Disclosed is a method of forming chewing gum, the method including providing a pair of rollers, sizing a gum mass into a gum sheet having a substantially uniform first thickness using the pair of rollers, and further sizing the gum sheet to include a substantially uniform final thickness downstream of the pair of rollers, wherein the first thickness is greater than 10% thicker than the final thickness, and the final thickness is between about 0.3 mm to 10 mm.

### FIELD OF THE INVENTION

The present invention relates to gum manufacturing methods and systems and more particularly relates to gum forming systems and methods.

### BACKGROUND OF THE INVENTION

Typically, the process of making and packaging gum products is time-consuming and involves a significant amount of machinery. The process of making and packing gum products can include mixing and producing a finished gum as a non-uniform output, extruding and forming the finished gum into loaves, conditioning the loaves of the finished gum, extruding the loaves into a continuous thin sheet of the finished gum, rolling the continuous sheet through a series of rollers to a uniform reduced thickness, scoring and dividing sheets into individual scored sheets, conditioning the individual sheets in a conditioning room, dividing sheets into gum pieces, and packaging the gum pieces. Such processes of making and packaging gum products are disclosed in U.S. Pat. No. 6,254,373 assigned to the predecessor of interest of the present assignee, and U.S. patent application Ser. No. 12/352,110 assigned to the present assignee; the teachings and disclosures of which are hereby incorporated by reference in their entireties to the extent not inconsistent with the present disclosure.

Traditional sizing machinery may include a sizing extruder that forces the chewing gum through a small rectangular orifice (e.g. a rectangular orifice having dimensions of about 25 mm by 457 mm). A relatively sizeable amount of force is required as the orifice size gets smaller (e.g. a 30 HP drive may be needed for sufficient output/production volume). Typically, the product exiting the sizing extruder is still much too thick. As a result, many prior systems typically employ a series of sizing rollers arranged in sequence over a conveyor belt to gradually and progressively reduce the thickness of gum from around 25 mm to typically about 2-6 mm. To prevent sticking of gum to the rollers, dusting with a suitable powder agent is typically employed. Thereafter, a scoring roll and dividing roll may be used to generate thin sticks, or somewhat shorter and fatter slabs of gum, or pellets (any of the foregoing sticks, slabs, pellets or other dimension gum maybe referred to as “sized gum.”) Such traditional lines also typically will necessitate a fair amount of subsequent cooling and/or conditioning prior to packaging as warm pliable product does not package well.

The present invention is directed toward improvements and advancements over such prior systems and methods of making and packaging gum products.

### BRIEF SUMMARY OF THE INVENTION

Disclosed is a method of forming chewing gum, the method including providing a pair of rollers, sizing a gum mass into a gum sheet having a substantially uniform first thickness using the pair of rollers, and further sizing the gum sheet to include a substantially uniform final thickness downstream of the pair of rollers, wherein the first thickness is greater than 10% thicker than the final thickness, and the final thickness is between about 0.3 mm to 10 mm.

Also disclosed is a method of forming chewing gum along a gum forming line, the method including sizing an unshaped gum mass into a gum sheet including a substantially uniform thickness between about 0.3 mm to 10 mm, the sizing being achieved entirely via at most five pairs of rollers.

### BRIEF DESCRIPTION OF THE DRAWINGS

The accompanying drawings incorporated in and forming a part of the specification embodies several aspects of the present invention and, together with the description, serve to explain the principles of the invention. In the drawings:

FIG. 1 is a schematic illustration of a gum manufacturing system according to a first embodiment; and

FIG. 2 is a schematic illustration of a gum manufacturing system according to a second embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following disclosure will detail particular embodiments according to the present disclosure, which provide improvements for forming a chewing gum sheet and facilitating heat transfer from or to the chewing gum sheet. In one embodiment, a system includes a set or pair of rollers for forming a gum structure/mass into a continuous web or sheet having a desired thickness and a width, while imparting temperature control to the gum at the same time. Rollers such as but not limited those described in U.S. application Ser. No. 13/522,767, which is herein incorporated by reference in its entirety, are contemplated herein. Moving walls such as the moving walls described in U.S. Application No. 61/510,119, which is herein incorporated by reference in its entirety, are also contemplated.

The chewing gum included in the chewing gum mass and sheet discussed above will be referred to as “chewing gum” or “gum” and includes, but is not limited to, compositions ranging from and inclusive of compounded elastomer to finished gum, which may include compounded elastomer in addition to some compounding aids, master batch gum base, compounded elastomer in addition to some subsequent gum ingredients, compounded elastomer in addition to some gum base ingredients and some subsequent gum ingredients, gum base, gum base in addition to some subsequent gum ingredients, master batch finished gum, and finished gum. Certain compositions of chewing gum may have a non-uniform texture and/or a multi-layered composition. Although, most of the embodiments discussed herein involve chewing gum (particularly finished chewing gum), other confectioneries that do not contain an elastomeric compound can also be formed, sized and/or conditioned using the systems discussed below.

The system can form the gum mass into a gum sheet including a desired width and thickness with a lower variance than conventional lines. Further, the system can eliminate a need of a sizing-type extruder. By eliminating the use of the sizing-type extruder, the system can operate at a much lower energy than the conventional lines including the sizing-type extruder. Therefore the system may reduce energy consumption and shear force introduced when deforming a gum structure or mass into a gum sheet of a desirable thickness, thereby potentially preserving more shear or temperature sensitive ingredients in the gum.

Further, the system can produce a much wider width of the sheet of the gum when compared to the sizing-type extruder of conventional lines, and can also eliminate a need of powder dusting material. By eliminating the use of powder dusting material, a cleanup time for change over can be reduced to a fraction of the conventional rolling and scoring lines, thereby significantly reducing a production down time. This additionally reduces overall cost of operating the line because there is no need for the additional dusting material. In addition to these advantages over the conventional lines, the rollers of the system can also be chilled (or heated in some embodiments) to provide cooling during deformation of the gum mass to a desired thickness and width. Therefore, the system according to some embodiments can form and cool or heat the gum mass all at one step, thereby proving many advantages over conventional gum lines.

Further, gum products manufactured according to embodiments of the present disclosure can be structurally distinguishable from gum products produced using conventional gum lines, as the systems may result in different crystallization of gums by quick cooling of the gum and eliminating a high shear sizing-type extruder. Further, more aesthetically pleasing chewing gum production can occur by eliminating use of powder dusting materials and producing chewing gum products having a desired thickness and width with relatively small thickness and width variances when compared to those produced via conventional gum lines.

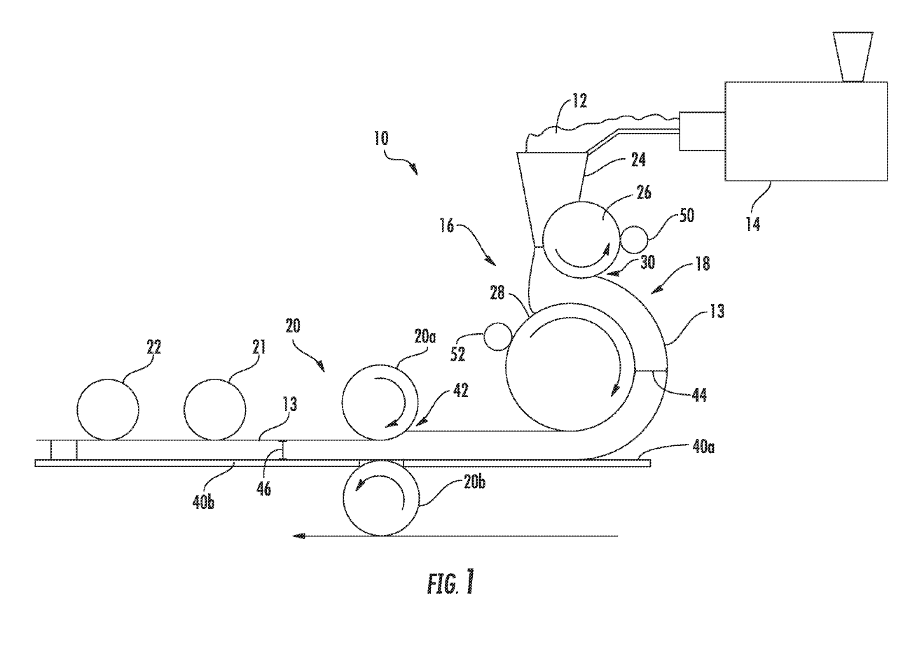

Referring now to FIG. 1, a gum manufacturing system 10 for forming a chewing gum mass 12 into a chewing gum sheet 13 of a desired thickness is illustrated. The gum manufacturing system 10 generally includes a gum mixing station 14 and a gum forming or sizing station 16 that includes a pair of rollers 18 and a further forming or sizing device 20 downstream thereof. In the exemplary embodiment shown in FIG. 1, the further forming device 20 is a pair of additional rollers 20a, 20b, though a plurality of horizontally displaced pairs of rollers, as well as other forming devices (some of which being discussed later in the disclosure) are also contemplated. The gum manufacturing system 10 is also shown here with and optional scoring roller 21 and cutting roller 22.

The gum mixing station 14 may include a single mixer or multiple mixers equipped with various mixer components and/or mixer feeding systems for processing gum ingredients to make a gum structure or mass. The mixers may be, for example, one or more batch mixers and/or one or more continuous mixers such as an extruder. Further, the gum mixing system 14 may merely be a melting system that melts previously formed gum into a condition in which it can be subsequently formed.

The gum forming station 16 provides for sizing and potentially temperature control (i.e. cooling or heating) and reduces the need for gradual progressive sizing of the gum by providing a substantial amount of thickness reduction at the rollers 18. In exemplary embodiments that will be explained, use of the gum forming station 16 eliminates the need for sizing type extruders (e.g. the extruders that form wide thin ribbons of gum), reducing a processing force or average strain and temperature on the chewing gum, and leading to less attrition of pressure sensitive materials. The system may also increase the amount of shear or temperature sensitive ingredients remaining intact during processing.

Referring more specifically now to the embodiment shown in FIG. 1, chewing gum 12 is transported from the gum mixing station 14 to the gum forming station 16. Upon leaving the mixing station 14, the gum 12 may be generally irregular or otherwise a non-uniform thickness of material, though more regular shapes such as loaves, rope, or sheets (which may be formed by traditional processes that may desirably employ low shear forming devices and extruders) are also possible upon arrival at a hopper or collector 24 of the forming station 16 (where the once uniform or regular shapes may become non-uniform again).

As shown in FIG. 1, the first illustrated embodiment of the overall system 10 notably does not include a sizing type extruder or multiple rollers for progressively reducing thickness. Thus, one feature and advantage according to some embodiments is elimination of sizing type extruder systems that may require high shear in extruding the gum, and are limited to producing a gum sheet having a maximum width of about 220 mm to 460 mm due to the high shear nature of the process.

The gum mass 12, which has not passed through a sizing type extruder, is transported from the mixing station 14 to the hopper 24 at an upstream or entry point of the forming station 16. The forming station 16 includes the pair of moving rollers 18, which, in this embodiment, are an upper roller 26 and a lower roller 28. The rollers 18 are externally driven, for example by an operably coupled motor. In an exemplary embodiment, each of the rollers 18 is provided with a motor, such that a rotational speed of each of the rollers 18 can be controlled independently.

The hopper 24 is disposed proximate the rollers 18, and may be used for upstream surge control, capacity and feed control. The hopper 18 constrains, accumulates, and feeds the gum mass 12 into an inlet or gap region 30 generally between the rollers 18. The hopper 18 can be configured to receive the gum mass 12 in any desirable form, and include a width adjustable output proximate the gap 30 that is configured to accommodate any reasonably desirable width of the gum sheet 13. In an exemplary embodiment, the hopper output and upper and lower rollers 26, 28 are configured to accommodate the gum sheet 13 produced to a width of between about 25 mm to 1 m, or perhaps more. It may be desirable to have a wider sheet of the gum of greater than about 0.6 m in width so as to be able to provide a substantial gum mass volume that can operate at slower speeds while generating sufficient output.

The chewing gum mass 12 falls through the hopper 24 via gravity and perhaps the assistance of guide rollers disposed within the hopper 24. In the exemplary embodiment of FIG. 1, as the gum mass 12 exits the hopper output it is disposed upon and is guided by the lower roller 28 toward the upper roller 26 and gap 30 between the upper and lower rollers 26, 28. The counter rotating upper roller 26 and lower roller 28 pull the gum mass 12 between the rollers 18 and through the gap 30 to form and size the gum mass 12 into the gum sheet 13 as will be explained in more detail below.

In the embodiment shown in FIG. 1, the rollers 18 include rotational axes that are horizontally offset by a horizontal offset. The rollers 18 are also vertically offset, with the horizontal and vertical displacement of the axes and rollers themselves facilitating creation of the gap 30.

The rollers 18 and the gap 30 are configured to apply a compressive or deforming force onto the gum mass 12 to form the gum sheet 13 with a first thickness 44, which, at a point downstream of the gap 30 but upstream of the second set of rollers 20a, 20b, has a generally uniform thickness that at least substantially corresponds to a gap height or clearance. The upper roller 26 and the lower roller 28 counter rotate to pull the gum mass 12 through the gap 30. This pulling or dragging of the mass 12 by the rollers 18 results in a drag flow of the gum through the gap 30. In the exemplary embodiment shown in FIG. 1, the upper roller 26 rotates in a counter clockwise direction, while the lower roller 28 rotates in a clockwise direction. As the gum mass 12 is pulled through the minimum distance of the gap 30, the gum mass 12 mass is deformed between the rollers 18, with this deforming/sizing being substantially extensional.

Immediately prior to being sized by the rollers 18 (i.e., exiting the hopper 24), the gum mass 12 may be substantially unshaped. It should be noted that an “unshaped” gum mass may be defined as any mass that is not, in its current state, sized or formed via extrusion, deforming, or any other means, though the gum mass may have been sized or formed in such a manner prior to being in this current state. In other words, dimension of the gum sheet 13 are created independently of the shape and dimensions of the gum mass 12. It should be noted however that the width of the exit or output from the hopper 24, the gap 30, and the sheet 13 may all be substantially the same. In addition, an exemplary embodiment of the gum mass 12 may include a thickness dimension of greater than 3 times the gum sheet 13, and more particularly 10-70 times the gum sheet 13, just upstream of the gap 30.

The pair of rollers 18 compresses and deforms the gum mass 12 as it passes between the upper and lower rollers 24, 26 to provide a generally uniform thickness, such that the thickness of the gum sheet 13 is preferably within about 20% cross-web variance, more preferably within about 10% cross-web variance, and most preferably within about a 5% cross-web variance, or less. For example, if a desired thickness 44 of the gum sheet 13 exiting the pair of rollers 18 is 6 mm, the gap 30 (and particularly the minimum distance of the gap) between the upper and lower rollers 26, 28 is adjusted such that the thickness across the width of the gum sheet 13 is preferably between about 4.8 and 7.2 mm, and more preferably between about 5.2 and 6.6 mm. As a result, a significant degree of precision and accuracy can be accomplished with the pair of rollers 18 for forming chewing gum. Some variance is expected with various gum recipes due to variations in bounce back and shrinkage due to variations in elasticity, viscosity and resiliency of a given gum recipe. The gum sheet 13 having a generally uniform thickness 44 may subsequently expand in its thickness or shrink in its thickness depending on a formulation of the gum. Further, the gum sheet 13 having a generally uniform thickness 44 may subsequently be shaped, textured, and/or printed, which may alter the generally uniform thickness.

The pair of rollers 18 can be configured to have various diameters and widths depending on physical properties of the gum, a desired first thickness 44 or final thickness 46 (the final thickness 46 being discussed in greater detail below), a final width of the gum sheet 13, and a desired temperature of the gum sheet 13 exiting the rollers 18. In the embodiment shown in FIG. 1, the lower roller 28 has a larger diameter than the upper roller 26. However, in other embodiments, the upper roller can have a larger diameter than the lower roller, or the rollers can have a same diameter. Desirably, the lower roller 28 has a diameter between about 0.5 m and 3 m and a width between about 0.6 m and 1.3 m; and the upper roller 26 has a diameter between about 0.25 m and 1 m with a similar width. As illustrated, preferably the roller that carries the gum for several degrees of rotation is relatively larger in diameter for certain cooling/heating and/or setting effects as discussed later on.

While narrower rollers are possible, the rollers having widths between about 0.6 m and 1.3 m or wider provides the opportunity to produce a gum ribbon or sheet that is about the same in width, typically at least slightly narrower. Therefore, the rollers 18 can provide substantial gum capacity improvements over the conventional thickness reduction process involving the sizing type extruder. The pair of rollers 18 thus can provide a gum sheet that is 50 mm to 50 cm or more than 50 cm in width (width of the gum sheet 13 being measured in a direction substantially perpendicular to direction of gum movement through the system 10), and 125%-300% (or more) wider gum ribbons or sheet of the finished sized gum than conventional sizing type forming extruder with progressive size reduction rollers, and as noted throughout, while using significantly less energy. The pair of rollers 18 thus can also provide a gum rope that is less than 50 mm, or 20 mm to 50 mm, and 25 mm to 45 mm, with gum including a width under 50 mm being defined as rope or perhaps ribbon. Further, the hopper 24 and pair of rollers 18 can produce a gum sheet 13 having a desired width within a relatively small variance. In one embodiment, the hopper 24 and rollers 18 can produce a gum sheet 13 having a desired width preferably within 20% variance, more preferably within 10% variance, and most preferably within 5% variance or less. With a wider gum material, the speed of gum forming process can be reduced substantially if desired while still processing the same amount of gum as traditional rolling and scoring lines or higher speeds can be used to result in greater gum volume production.

Downstream of the rollers 18 is another forming or sizing device 20 which, in the exemplary embodiment shown in FIG. 1, is additional rollers 20a, 20b. In this embodiment, the rollers 20a, 20b may be finishing rollers as typically found in a rolling and scoring line that may impart final sizing adjustments relative to final thickness 46 and width of the sheet 13, as well as being capable of other finishing processes such as embedding of inclusions. The rollers 20a, 20b are disposed at a break in the conveying device, which is demonstrated in the Figures via conveying device 4a, and conveying device 40b. The space between the two rollers 20a and 20b creates a second forming gap 42 that, depending on the desired thickness of the gum sheet 13, combines with the gap 30 to size the gum sheet 13 to its final (or substantially final) thickness 46 of between about 0.3 mm to 10.0 mm.

Forming the gum sheet 13 to its desired thickness between about 0.3 mm to 10.0 mm occurs via formation to the first thickness 44 via the gap 30 and formation to the final thickness 46 via the second gap 42, wherein the first thickness 44 is greater than 10% thicker than the final thickness 46. In an exemplary embodiment such as that shown in FIG. 1, wherein the further forming device 20 is a pair of rollers 20a, 20b or a series of similar roller pairs that are horizontally displaced, the majority of the sizing occurs in the gap 30. For example, the sizing created by the first gap 30 and second gap 42 creates a first thickness is greater than 10%, 11%, 12%, 13%, or 14%, and less than 15% thicker than the final thickness, greater than 10%, 11%, 12%, 13%, 14%, or 15% and less than 20% thicker than the final thickness greater than 10%, 11%, 12%, 13%, 14%, or 15% and less than 30% thicker than the final thickness greater than 10%, 11%, 12%, 13%, 14%, or 15% and less than 40% thicker than the final thickness, or greater than 10%, 11%, 12%, 13%, 14%, or 15% and less than 50% thicker than the final thickness. In this manner, the rollers 26, 28 impart a majority of the sizing to the final thickness between about 0.3 mm to 10.0 mm, while the downstream rollers 20a, 20b, or series of horizontally displaced pairs of rollers merely finish the sizing to the final thickness 46. In an exemplary embodiment, the number of pairs of rollers including the first pair 18 and downstream rollers that make up the downstream forming device 20 is less than a number of sizing rollers used in a traditional rolling and scoring process, more particularly no more than five pairs of rollers, and more particularly two or less. That is, in an exemplary embodiment, the system 10 may include the first pair of rollers 18, and one pair, two pairs, three pairs, or four pairs of additional downstream rollers such as rollers 20a, 20b. By sizing the gum to 130%, 120%, or 110% of its final thickness 46 via the pair of rollers 18, and then finishing the sizing via the downstream forming (using 1-4 additional pairs of rollers 20a, 20b), the system 10 is afforded more flexibility in making relatively minor adjustments in sizing without effecting main sizing operation (i.e. the first pair of rollers 18).

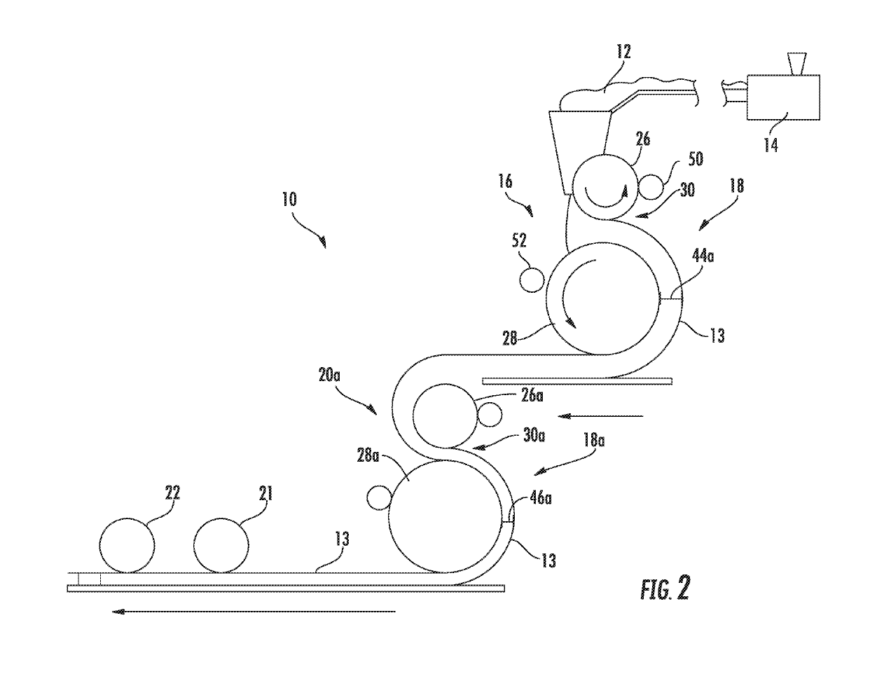

While FIG. 1 shows a further downstream forming device 20 to be the pair of roller 20, 20a, FIG. 2 shows another exemplary embodiment of a further downstream forming device 20a. In this embodiment, the system 10 remains essentially the same, except the further forming device 20 is another set of rollers 18a. The rollers 18a are the same as rollers 18. There is an upper roller 26a and a lower roller 28a, as well as a gap 30a.

Similarly to the embodiment shown in FIG. 1, depending on the desired thickness of the gum sheet 13 the downstream gap 30a combines with the gap 30 to size the gum sheet to a final (or substantially final) thickness of between about 0.3 mm to 10.0 mm. Forming the gum sheet 13 to its desired thickness between about 0.3 mm to 10.0 mm occurs via formation to a first thickness 44a via the gap 30 and formation to a final thickness 46a via gap 30a, wherein the first thickness 44a is greater than 10% thicker than the final thickness 46a. In exemplary embodiments such as those shown in FIG. 2 wherein the further forming device is another set of forming rollers 18a, the majority of the sizing may not necessarily occur in the gap 30. For example, the first thickness may be at least twice, three times, four times, and five times as thick as the final thickness.

In all of the above discussed embodiments, it is noted that high shear extruders are avoided in forming the gum sheet 13 to its final thickness of between about 0.3 mm to 10.0 mm. In addition, in each of these embodiments, the first thickness 44, 44a is at least 0.33 mm.

In each of the embodiments shown in FIGS. 1-2, the rollers 26, 26a, 28, 28a, 20a, and 20b may be configured to have a smooth surface finish. The upstream pairs of rollers 18, 18a may also be configured with any desirable actuation devices, such as but not limited to a servomechanism(s) that controls vertical positioning of the rollers 26, 26a and 28, 28a relative to each other, and thereby adjusts the gap 30, 30a. Similarly, the rollers 20a, 20b may be actuatable toward and away from each other to adjust the gap 42.

The upper roller 26, 26a and the lower roller 28, 28a can run at various rotational speeds. These pairs of rollers 18, 18a can run at a same rotational speed or different rotational speeds. The rotational speed of each of the rollers can be selected depending on physical properties of the input gum and an amount of heat transfer desired via the rollers. In exemplary embodiments, the lower roller 28, 28a, which may configured to have a larger diameter than the upper roller 26, 26a, is configured to run at a higher rotational speed than the smaller upper roller. Further, a relative rotational speed of rollers 26, 26a, and 28, 28a can be adjusted to produce desired quality of the gum sheet 13, such as surface characteristics, thickness tolerance, temperature, etc.

In exemplary embodiments, the rollers 26 and 28, as well as the rollers 26a and 28a may be configured to run at a same linear speed or at different linear speeds as measured at the tangent of the surface of the rollers. In one embodiment, one roller is set at a constant linear speed, while a linear speed of the other roller can be varied ±30% of the constant linear speed of the roller. For example, a linear speed of the lower roller 28, can be set at 3 m/min, while a linear speed of the upper roller 26, may be controlled between 2.1 m/min and 3.9 m/min. In such embodiment, the linear speed of the upper roller 26, 26a may be adjusted within the set range to achieve a smoother surface of the gum and to minimize wrinkling of the gum. Alternatively, the upper roller 26, 26a may be set at a constant linear speed, while the linear speed of the lower roller 28, 28a may be controlled within a desired range. A linear speed of one roller can be varied relative to a linear speed of the other roller within ranges of ±40%, ±30%, ±20%, or ±10%, depending on characteristics of a gum and a desired thickness and a width of the gum sheet 13 to maximize the smoothness and minimize wrinkles and other irregularities on the gum surface. In a different embodiment, the rollers 26, 26a, and 28, 28a having different diameters can be configured to run at a same linear speed (e.g. same speed at the tangent; but different angular speed in that the smaller roller rotates faster). Notably however, the downstream pair of rollers 20a, 20b, as well as the downstream pair of rollers 26a, 28a, runs at greater speeds (i.e. surface speeds) than the upstream rollers 26, 28, so as to allow the downstream rollers to pull and extend the sheet 13 downstream for sizing. Indeed, a decrease in thickness from thickness 44 to thickness 46, as occurs after the gum has passed through the gap 42 or 30a, results in a decrease in cross-sectional area of the sheet 13. In order to account for this decrease in cross-sectional area, the velocity of the rollers 20a, 20b or 26a, 28a should increase relative to the velocity of rollers 26, 28. For example, if the upstream pair of rollers 26, 28 are running at 20 meters/min and the final thickness 46 is about 20% less than the first thickness 44, then the velocity of the rollers 20a, 20b or 26a, 28a should be 24 meters/min. Similarly, if the conveyor 40a is running at 20 meters/min, then the conveyor 40b should run at 24 meters/min. The dimensional configurations and material for the rollers 26, 26a, and 28, 28a and support structures thereof are engineered to minimize or eliminate deflection in the rollers 26, 26a, and 28, 28a. The rollers 26, 26a, and 28, 28a are set up to provide a generally uniform cross web spacing 30, 30a (gap) between the rollers 26, 26a, and 28, 28a from one end of the rollers to the other end. However, some high viscosity and/or low elasticity gum compositions can impart a high stress to the rollers 26, 26a, and 28, 28a as the rollers deform the gum mass 12. Some very viscous gum structures provided as the mass 12 may require additional force, such as additional augers in the hopper 24, pushing the gum mass 12 into the spacing 30 between the rollers 26, 28, and downstream to the further sizing device 20, 20a. Such viscous gum structures can exert high stress on the rollers 26, 26a, and 28, 28a. Such stress can result in a deflection in the rollers 26, 26a, and 28, 28a, and resultant uneven spacing, and undesirable non-uniform cross-web thickness.

Thus, in one exemplary embodiment, the rollers 26, 26a, and 28, 28a are strengthened by providing additional structural supports and/or supporting the rollers closer to the ends of the rollers to minimize or eliminate the deflection in the rollers. In one embodiment, the rollers 26, 26a, and 28, 28a are strengthened and supported such that the maximum deflection between the rollers is maintained under 0.5 mm, preferably under 0.1 mm when processing gum mass 12 with high viscosity and/or low elasticity. Further, the roller deflection can also be minimized or eliminated by increasing a diameter of the rollers or forming the rollers from materials having increased strength to withstand the stress imparted by the gum mass. For wider rollers, more strength or stiffness is needed to withstand the stress and a larger diameter roller can be beneficial in providing sufficient roller stiffness to minimize the deflection. Thus, a diameter to width ratio of the rollers is carefully selected considering physical properties of gum mass 12 and desired gum sheet thickness to minimize the deflection in the rollers.

Alternatively, physical properties of the gum mass 12 can be adjusted to minimize the deflection in the rollers 26, 26a, and 28, 28a (and even the rollers 20a, 20b) during the compressive forming and sizing process. For example, a temperature of the gum from the mixer 14 may be raised to improve deformability of the gum mass 12 entering the pair of rollers 26, 26a, and 28, 28a and sheet 13 with a first thickness 44a. In other embodiments, one or both of the rollers 26, 26a, and 28, 28a may be heated to transfer heat to the gum mass 12 and sheet 13, thereby decreasing viscosity and improving compressibility/formability of the gum sheet 13. An amount of pressure and heat exerted on the gum mass 12 or gum sheet 13 sized to the first thickness 44a can have various effects on the final gum product.

Another feature of the embodiments discussed above is that the lower roller 28, 28a that carries the gum over several degrees of rotation serves to transfer heat from or to the gum sheet 13 quickly and efficiently due to the relatively thin state of the gum and due to heat transfer via conduction. To facilitate the same, in one embodiment, at least the lower roller (and preferably both rollers) may be chilled or heated. In some embodiments, the pairs of rollers 18, 18a may be provided with internal channel(s) wherein a heating or cooling fluid such as tempered water or lower freezing point fluid flows for heating or cooling the rollers. Therefore, the surface temperature of the rollers may be adjusted from about −15° C. to 90° C. In one embodiment, the surface temperature of the rollers 26, 26a, and 28, 28a can be controlled between about 0° C.-90 C.° by circulating a cooling fluid or heating fluid having a temperature between about 0° C.-90 C.° within the rollers. According to one embodiment, the forming rollers are chilled to a surface temperature between about 5° C. to 25 C.°; and preferably around 15 C.°. This has several advantages as reducing or eliminating later conditioning/cooling, and reducing flash off of heat sensitive ingredients such as flavors as the gum is cooled much earlier in the process. In a different embodiment, the forming rollers are heated to a surface temperature between about 40° C. to 60 C.°, which can facilitate forming of a gum sheet and reduce thickness variation of the gum sheet.

In an exemplary embodiment, the gum mass 12 having an average temperature between about 40° C.-60 C.° is fed between the pair of forming or sizing rollers 18. One or both rollers 26, 28 are heated to a surface temperature between about 30° C.-70 C.°, more preferably between about 40° C.-60 C.° to be closely matched to the temperature of the finished gum mass 12 (the rollers 26a, 28a may be heated similarly). Such heating of the roller(s) facilitates forming of the gum and controls the viscosity of the gum, which is carried by the lower roller. If the surface temperature of roller(s) 26, 26a, and 28, 28a is too high, in some embodiments, the gum may heat and then become too sticky and stick to the roller(s). If the surface temperature of the roller(s) is too low, the local viscosity of the gum may increase to a point, wherein the gum becomes too hard for forming or may not stay on the lower roller 28, 28a. Thus, depending on a formulation of the gum, the surface temperature of the roller(s) may be set to aid in preventing the gum sticking to the roller(s), and to facilitate forming of the gum.

The web of gum formed, sized, and cooled or heated using the rollers 26, 28 and 20a, 20b and/or rollers 26, 28, and 26a, 28a can have a temperature gradient across the thickness 44 and/or 46 of the gum sheet 13. This is because the gum sheet 13, a substantial amount of which is elastomer, is not a good thermal conductor, and thus the middle portion of the gum may remain at a different temperature than that of surfaces, which are in direct contact with the rollers. Such a temperature gradient can be amplified when the rollers, particularly 26, 26a, or 28, 28a are maintained at different temperatures. For example, in one embodiment, the upper roller(s) 26, 26a are heated to a surface temperature of about 50° C. and the lower roller(s) 28, 28a are chilled to a surface temperature of about 5° C., wherein the gum has an average temperature of about 40° C. is formed, sized and conditioned into the gum sheet 13 having a thickness as measured at 44 and/or 46 of about 2 mm. In this embodiment, the gum sheet 13 can have a large temperature gradient, wherein a temperature of the gum surface in contact with the lower roller is close to the surface temperature of the lower roller of about 5° C. and a temperature of the gum surface in contact with the heated upper roller is close to the surface temperature of the upper roller of about 50° C. with a temperature of the gum sheet 13 therebetween varying from about 5° C. to about 50° C. In such embodiments, crystallization of the chilled gum surface can be substantially different than that of the heated gum surface, as a low temperature conduction cooling of the gum sheet via the chilled roller can result in a very different crystallization compared to a slow cooled gum sheet, for example by convection. Even in embodiments, wherein both rollers 26, 26a, and 28, 28a are chilled to a same temperature, the gum sheet 13 may have a temperature gradient across a thickness of the gum sheet, although much less than that of gum sheets 184 formed by rollers of different temperatures.

A temperature variation in an input gum entering the gum forming station 16 can have a significant impact on the temperature consistency of the gum sheet 13, both at thickness 44 and 46. This is because the temperature altering of the gum sheet 13 by conduction via the pair of forming roller(s) 18 and perhaps 18a occurs in a fraction of time when compared to traditional cooling and conditioning of the gum via convection, which can be hours or even days. As such, the temperature variation in the input gum mass can translate into a temperature variation in the gum web that is quick cooled, for example in less than one minute, by chilled roller(s) such as 18 and 18a. Thus, some embodiments can include measures to control a temperature variation of the input gum mass within a desired range. For example, a mixing extruder for preparing the input gum structure can be equipped with sophisticated temperature control modules to extrude the gum within the desired temperature range. In other embodiments, the gum manufacturing line 10 may include an optional conditioning unit between the mixer and the gum forming station 16 for conditioning the mass 12 to a desired temperature range.

Chilled forming rollers 26, 26a, 28 and/or 28a can effectively reduce a temperature of the relatively thin gum sheet 13, both at thickness 44 and 46, as it is carried by the chilled forming roller(s) for heat transfer. Therefore, in an exemplary embodiment, a relatively large diameter roller may be provided wherein the gum sheet 13 is carried over at least about ¼ a rotation (at least about 90 degrees and up to about 180 degrees) to provide a long residence time to facilitate heat transfer out of the gum sheet and to the chilled roller due to contact and conduction. The chilled fluid travelling through the rollers is excellent at maintaining the forming roller(s) to a surface temperature between about 5° C. to 25 C.°; and preferably around 15 C.°. The chilled forming roller(s) having a cold metal surface having a high thermal conductivity works effectively to reduce the temperature of the relatively thin chewing gum, preferably having a thickness less than 10 mm; and more preferably at 0.5-6 mm, by facilitating heat transfer from the gum sheet 13 to the cold metal surface. The heat transfer roller may advantageously be one or both of the pair of forming rollers, or may also independently be a separate roller upon which gum is transferred.

In an exemplary embodiment, the upper roller 26 (and perhaps roller 26a) includes a diameter of about 0.5 meter, and the lower roller 28 (and perhaps roller 28a) includes a diameter of about 1 meter, each being cooled to around 15° C. Use of the pair of rollers 18 may also provide the opportunity to eliminate dusting of the gum with talc or other particulate anti-sticking agent that are used in more conventional rolling reduction operations. This can avoid the need for dust collection equipment as used in traditional rolling and scoring lines; and can also be used to create a more aesthetically pleasing product that has more vibrant colors as dusting operations dull the final product color. Further, by eliminating the use of dusting powders, a clean up process of the gum manufacturing line 10 can be dramatically made easy, since a substantially large portion of residual mess requiring lengthy cleaning in conventional rolling and scoring lines is due to the use of powders and the large number of rollers. As such, the clean up time for a change over, which was hours, 10 hours in some conventional rolling and scoring gum lines, can be reduced to minutes according to some embodiments of the present invention. Therefore, the embodiments of the present invention can increase the productivity of the gum manufacturing line by substantially reducing clean up/change over time when compared to traditional rolling and scoring gum lines.

Turning now to an exemplary embodiment that may effectively replace the powder mentioned above, it should be appreciated that the upper roller 26, 26a may be equipped with an oiling roller 50 to lubricate the roller with a release agent such as food quality vegetable or mineral oil, which acts to prevent sticking of the gum to the rollers. Similarly, the lower roller 28, 28a may be equipped with an oiling roller 52 to lubricate the lower roller. Therefore, the gum forming system 16 eliminates the need of powder releasing agents such as talc or a polyol. Although each of the rollers is provided with the oiling roller in the embodiments of FIGS. 1 and 2, in other embodiments, only one of the upper and lower rollers may be provided with one oiling roller, or none of the rollers may be provided with an oiling roller when the rollers have a sufficiently low surface tension or adhesion to release the gum sheet 13 without aid of a releasing agent and the gum sheet 13 is sufficiently not tacky for subsequent scoring, cutting and packaging processes. Further, other lubricating systems, for example, a spray bar or a dipping basin can be used to apply a suitable liquid lubricator. The rollers may also be provided with a scrapper downstream of the gap 30, 30a to detach the gum sheet 13 from the surface of the roller 28, 28a onto a conveyor belt.

The upper roller 26, 26a may also be provided with a scraper near the gap 30, 30a to ensure the gum sheet 13 detaches from the surface of the upper roller, thereby facilitating the gum sheet 13 to travel on the lower roller. The lower roller 28, 28a may further be provided with a scrapper near the bottom of the lower roller to detach the gum sheet 13 from the surface of the lower roller onto the conveyor belt. In some embodiments, the conveyor belt may be adapted for cooling or heating to further condition the continuous sheet of gum sheet 13 similarly to the rollers discussed above.

The system 10 may also include a smoothing roller (not shown) downstream of the further sizing device 20, 20a. Upon exiting the pair of rollers gap 42, 30a, the conveyor belt 40 moves the gum sheet 13 with its final (or at least substantially final) thickness toward the smoothing roller. The smoothing roller is arranged preferably about 0.5 m to 3 m from the rollers 20a, 20b or lower roller 28a, more preferably about 1 m-1.5 m. The smoothing roller can remove surface imperfections, kinks, and may further reduce the thickness of the gum sheet 13, however usually any further reductions can be limited to 10% or less, and thus not have an effect on the final thickness or substantially final thickness of the sheet 13 (indeed, reduction in thickness by 10% or less, for purposes of this disclosure, will not be considered to impact a “substantially” final thickness of the sheet 13), while achieving advantages in that progressive rolling reductions are not necessitated. The embodiments shown in FIGS. 1 and 2 output the continuous gum sheet 13 having a thickness 46 within 10% of a desired final thickness of the final gum product (and thereby at a substantially final thickness as defined above), and the smoothing roller is configured to adjust the thickness of the gum sheet 13 by less than 10% (i.e. simply by smoothing, and thus again, not having an effect on a substantially final thickness). For example, in an implementation wherein the desired final thickness of a stick gum product is 2.0 mm, the gap 30 along with the gap 42 and/or gap 30a can be adjusted such that the continuous sheet gum sheet 13 has a generally uniform thickness of about 2.1 mm. In this implementation, the smoothing roller is arranged relative to the conveyor belt 40 to remove imperfections and kinks in a manner that may reduce the generally uniform thickness to about 2.0 mm.

In the exemplary embodiment of FIG. 1 the system 10 further includes the scoring roller 21, a lateral dividing or cutting roller 22 downstream of the gap 42, 30a (and compression roller if used). The scoring roller 21 and the lateral dividing roller 22 score and divide the gum sheet 13 with the thickness 46 into individual scored sheets. The scored sheets may then be conveyed to cooling tunnel for further conditioning (though the cooling tunnel may be rendered unnecessary in light of the improved cooling capabilities provided by the rollers 18, 18a). Thereafter, the gum may be transported to further processing and packaging equipment for producing packaged gum products, perhaps in a single line with the system 10. In some embodiments, the scoring roller 21 and the dividing roller 22 may be replaced with other gum shaping solutions, such as a drop-roller, a die cutter, pelletizer or other similar gum shaping equipment (provided the sheet is cooled to a sufficient extent). As such, the gum manufacturing system 10 can produce a chewing gum having various final shapes, such as slabs which can subsequently be packaged, or pellets that are subsequently coated.

Although the system 10 is shown as a continuous line including the gum mixing system 14 in the Figures, in other embodiments, one or more of these components of the gum manufacturing system 10 may be located in different parts of a manufacturing plant or even in a different manufacturing plant. For example, in one embodiment, the gum mixing system 14 is located in one plant, and the gum forming system 16 and other subsequent components, such as the scoring and dividing rollers and packaging components, are located in a different plant, wherein the mixed gum mass 12 transferred from one plant to the other for subsequent processes.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-34. (canceled)

35. A method of forming chewing gum, the method comprising:
providing a pair of rollers;
sizing a gum mass into a gum sheet having a substantially uniform first thickness using said pair of rollers; and
further sizing the gum sheet to include a substantially uniform final thickness downstream of said pair of rollers, wherein said first thickness is greater than 10% thicker than said final thickness, and said final thickness is between about 0.3 mm to 10 mm.

36. The method of claim 35, wherein said first thickness is greater than 10% and less than 15% thicker than said final thickness.

37. The method of claim 35, wherein said first thickness is greater than 10% and less than 50% thicker than said final thickness.

38. The method of claim 35, wherein said first thickness is at least twice as thick as said final thickness.

39. The method of claim 35, wherein said first thickness is at least five times as thick as said final thickness.

40. The method of claim 35, wherein said first thickness is at least 0.33 mm.

41. The method of claim 35, wherein said pair of rollers includes two vertically displaced rollers.

42. The method of claim 35, wherein said further sizing is achieved via at least one additional roller, said at least one additional roller. being at least one of a plurality of horizontally displaced rollers and at least one second pair of vertically displaced rollers.

43. The method of claim 35, wherein said sizing said gum mass into said gum sheet with said first uniform thickness includes driving the pair of rollers in opposite directions to pull the gum mass through a gap between the pair of rollers, and compressing the gum mass to form the gum sheet with said first uniform thickness.

44. The method of claim 43, wherein said compressing includes applying an even cross web compressive force on said gum sheet to achieve said first uniform thickness of said gum sheet, said gum sheet with said first uniform thickness having a cross web thickness variance less than 10%.

45. The method of claim 35, wherein said gum sheet with said second uniform thickness includes a cross web thickness variance less than 10% and a width greater than about 0.6 meters.

46. The method of claim 35, wherein said thickness of said gum sheet expands by less than 10% after said further sizing to said final thickness.

47. The method of claim 35, further comprising feeding said gum mass into a hopper including a pair of feeding rollers, conveying said gum mass using said feeding rollers, directing said gum mass to said pair of rollers.

48. The method of claim 35, wherein said sizing and said further sizing produces said gum sheet having a width between 0.6 m and 1.2 m.

49. The method of claim 35, wherein said final thickness is between 2 mm and 6 mm.

50. The method of claim 35, further including lubricating said gum sheet or said pair of rollers with a liquid lubricator, thereby producing said gum sheet free of powder dusting material.

51. The method of claim 35, further comprising heating said gum mass by heating at least one of said pair of rollers to lower a viscosity of said gum mass and increase a deformability of said gum mass during said sizing.

52. The method of claim 35, further comprising cooling said gum sheet via a cooling system associated with said further sizing.

53. The method of claim 35, wherein the gum mass has a thickness dimension of at least 10 times said gum sheet.

54. A method of forming chewing gum along a gum forming line, the method comprising:
sizing an unshaped gum mass into a gum sheet including a substantially uniform thickness between about 0.3 mm to 10 mm, said sizing being achieved entirely via at most five pairs of rollers.

55. The method of claim 54, wherein said at most five pairs of rollers is two pairs of rollers, said sizing being achieved entirely via said two pairs of rollers.

56. The method of claim 54, wherein said at most five pairs of rollers includes a first pair of rollers that is farthest upstream along the line relative to the remaining rollers in the line, wherein at least one roller in said first pair of rollers includes a greater diameter than at least one roller of said remaining rollers.

57. The method of claim 54, wherein said five pairs of rollers includes a first pair of rollers that is farthest upstream along the line relative to the remaining rollers in the line, wherein at least one roller in said first pair of rollers runs at a lesser velocity than at least one roller of said remaining rollers.
